(19) United States
(12) Patent Application Publication
(10) Pub. No.: US 2009/0224032 A1
(43) Pub. Date: Sep. 10, 2009

(54) SAMPLE ANALYZER, SAMPLE ANALYZING METHOD, AND COMPUTER PROGRAM PRODUCT

(75) Inventors: Keitarou KONDOU, Kobe-shi (JP); Hiroyuki MATSUURA, Kobe-shi (JP)

Correspondence Address: SUGHRUE MION, PLLC, 2100 PENNSYLVANIA AVENUE, N.W., SUITE 800, WASHINGTON, DC, 20037, US

(73) Assignee: SYSMEX CORPORATION, Kobe-shi (JP)

(21) Appl. No.: 12/372,291

(22) Filed: Feb. 17, 2009

(30) Foreign Application Priority Data
Mar. 6, 2008 (JP) 2008-056592

(51) Int. Cl. G06F 19/00

(52) U.S. Cl. 235/375

(57) ABSTRACT

A sample analyzer for analyzing a measurement sample prepared by mixing a specimen and a reagent includes a movement unit for moving at least one of a specimen container, a reagent container and an accommodation unit for accommodating the specimen container or the reagent container with identification information; an identification data acquirer for reading at least one of identification information provided to the specimen container, the reagent container or the accommodation unit; and a controller for controlling operations of the movement unit and the identification data acquirer such that the movement unit moves each identification information so that the identification data acquirer sequentially reads; the controller judges each identification information is normally read; the movement unit moves each identification information to be read again; and the identification data acquirer reads identification information at a read position is disclosed. A sample analyzing method and a computer program product is also disclosed.

### FIELD OF THE INVENTION

The present invention relates to a sample analyzer capable of analyzing a measurement sample prepared by mixing a specimen and a reagent, a sample analyzing method, and a computer program product.

### BACKGROUND

In a sample analyzer capable of analyzing a measurement sample prepared by mixing a specimen and a reagent, the specimen and the reagent are accommodated in a test tube, a container, and the like. The test tube, the container, and the like are attached with a barcode label containing identification information for identifying the accommodating specimen, reagent, and the like.

However, the types of specimen, reagent, and the like are enormous, and the types of test tube, container, and the like often are mixed depending on the providing manufacturing company. Therefore, the identification information may not be read due to the difference in that attached position of the barcode label, the difference in quality of the barcode label, or the like.

In order to respond to such failure in reading the barcode label, for instance, Japanese Laid-Open Patent Publication No. 6-130069 discloses an automatic analyzer for judging the presence of the barcode label itself, and re-reading after fine tuning the reading position of the barcode label with respect to the test tube attached with the barcode label when failing in reading. When failing in reading, the reading position is changed through fine tuning, so that reading may be normally carried out in time of re-reading even with respect to the test tube which reading failed.

However, in the automatic analyzer disclosed in Japanese Laid-Open Patent Publication No. 6-130069, when the presence of the barcode label, which reading failed, is confirmed, the reading position by the barcode reader is fine tuned, and re-reading is executed. Therefore, the reading of the next identification information cannot be executed until the re-reading of one identification information is completed, the time required for the reading process as a whole increases if re-reading occurs.

### SUMMARY OF THE INVENTION

The scope of the present invention is defined solely by the appended claims, and is not affected to any degree by the statements within this summary.

A first aspect of the present invention is a sample analyzer for analyzing a measurement sample prepared by mixing a specimen and a reagent, comprising: a movement unit for moving at least one of a specimen container, a reagent container, and an accommodation unit for accommodating the specimen container or the reagent container, wherein at least one of the specimen container, the reagent container and the accommodation unit is provided with identification information; an identification data acquirer for reading at least one of identification information provided to the specimen container, identification information provided to the reagent container, and identification information provided to the accommodation unit; and a controller for controlling operations of the movement unit and the identification data acquirer such that the movement unit moves each identification information so that the identification information data acquirer sequentially reads identification information; the controller judges whether or not each identification information is normally read by the identification data acquirer; the movement unit moves each identification information so that the identification data acquirer reads identification information again which judged as being not normally read; and the identification data acquirer reads identification information moved to a read position at which identification information is readable.

A second aspect of the present invention is a sample analyzer for analyzing a measurement sample prepared by mixing a specimen and a reagent, comprising: an identification data acquirer for reading identification information provided to identify at least one of a specimen container, a reagent container, and an accommodation unit for accommodating the specimen container or the reagent container; a movement unit for moving the identification data acquirer; and a controller for controlling operations of the movement unit and the identification data acquirer such that the identification data acquirer sequentially reads identification information; the controller judges whether or not each identification information is normally read by the identification data acquirer; the movement unit moves the identification data acquirer so that the identification data acquirer reads identification information again which judged as being not normally read; and the identification data acquirer reads identification information when the identification data acquirer is moved to a read position for reading identification information.

A third aspect of the present invention is a sample analyzing method executed in a sample analyzer for analyzing a measurement sample prepared by mixing a specimen and a reagent, comprising the steps of: (a) moving each identification information so that an identification data acquirer for reading at least one of identification information provided to a specimen container, identification information provided to a reagent container, and identification information provided to an accommodation unit for accommodating the specimen container or the reagent container sequentially reads identification information; (b) judging whether or not each identification information is normally read by the identification data acquirer; (c) moving each identification information so that the identification data acquirer performs re-reading of identification information judged as being not normally read after the reading of each identification information is terminated; and (d) reading identification information moved to a read position readable by the identification data acquirer.

A fourth aspect of the present invention is a computer program product, comprising: a computer readable medium; and instructions, on the computer readable medium, adapted to enable a general purpose computer to perform operations, comprising: (a) moving each identification information so that an identification data acquirer for reading at least one of identification information provided to a specimen container, identification information provided to a reagent container, and identification information provided to an accommodation unit for accommodating the specimen container or the reagent container sequentially reads identification information; (b) judging whether or not each identification information is normally read by the identification data acquirer; (c) moving each identification information so that the identification data acquirer performs re-reading of identification information judged as being not normally read after the reading of each identification information is terminated; and (d) reading identification information moved to a read position readable by the identification data acquirer.

### BRIEF DESCRIPTION OF THE DRAWINGS

FIG. 1 is a block diagram showing a configuration of a sample analyzer according to an embodiment of the present invention;

FIG. 2 is a block diagram showing a schematic configuration of a drive unit of the sample analyzer according to the embodiment of the present invention;

FIG. 3 is a partial plan view showing a brief overview of the sample analyzer according to the embodiment of the present invention;

FIG. 4 is a perspective view showing a configuration of a first container rack;

FIG. 5 is a perspective view showing a configuration of a second container rack;

FIG. 6 is a perspective view showing a configuration of the first container rack in a state of holding one container;

FIG. 7 is a perspective view showing a configuration of the second container rack in a state of holding three containers;

FIG. 8 is a flowchart showing processing procedures of the CPU of the controller of the sample analyzer according to the embodiment of the present invention;

FIG. 9 is an explanatory view of a region to be read on the first sample table and the second sample table;

FIG. 10 is an illustrative view of positional information stored in a storage device including the case where the container is accommodated in the first container rack or the second container rack;

FIG. 11 is a flowchart showing processing procedures in determining the reading order of the CPU of the controller of the sample analyzer according to the embodiment of the present invention;

FIG. 12 is a flowchart showing processing procedures of the CPU of the controller of the sample analyzer when obtaining a distance from the re-reading position.

FIG. 13 is an illustrative view of a screen displayed on the display device.

### DETAILED DESCRIPTION OF THE PREFERRED EMBODIMENTS

The preferred embodiments of the present invention will be described hereinafter with reference to the drawings.

A sample analyzer according to an embodiment of the present invention will be specifically described based on the drawings with a case of optically measuring and analyzing the quantity, degree of activity, and the like of a specific substance related to coagulation and fibrinolytic function of blood by way of example.

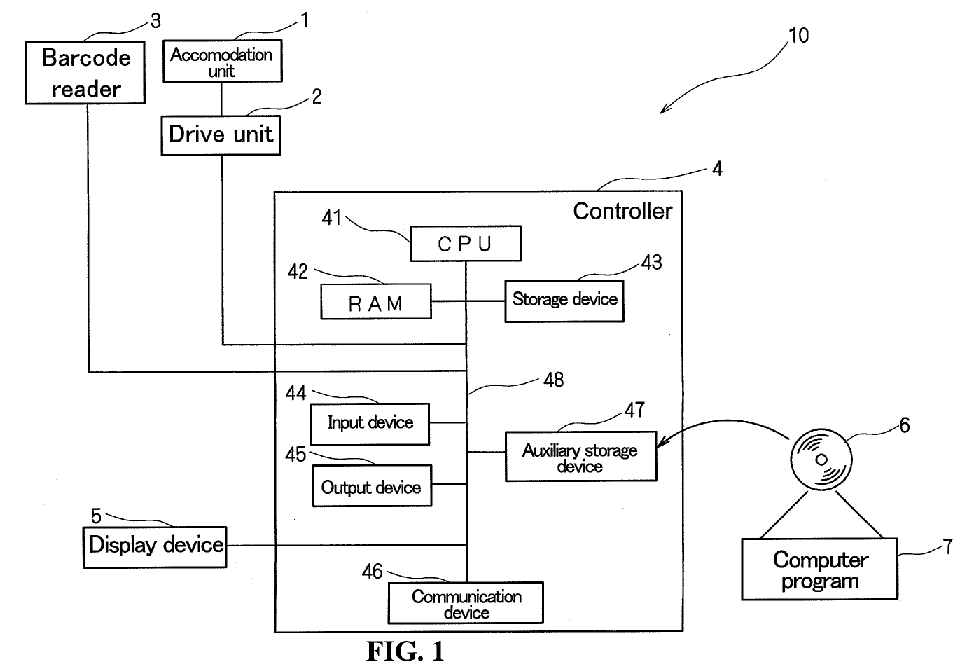

FIG. 1 is a block diagram showing a configuration of a sample analyzer according to an embodiment of the present invention. As shown in FIG. 1, in a sample analyzer 10 according to the present embodiment, an accommodation unit 1 for accommodating a specimen container, a reagent container or the like is movable by a drive unit 2, and a barcode reader 3 serving as identification information reader for reading barcode information attached to the specimen container, the reagent container, and the like accommodated in the accommodation unit 1 is arranged.

The drive unit 2 moves the accommodation unit 1 by using a stepping motor of constant current drive. The control of the operation of the drive unit 2 and the operation of the barcode reader 3 is performed by a controller 4 connected by a signal line.

The controller 4 is at least configured by a CPU (Central Processing Unit) 41, a RAM 42, a storage device 43, an input device 44, an output device 45, a communication device 46, an auxiliary storage device 47, and an internal bus 48 for connecting the above-described hardware. The CPU 41 is connected to each of the hardware of the controller 4 by way of the internal bus 48, and controls the operation of each of the hardware and controls the operation of the connected drive unit 2, the barcode reader 3, a display device 5, and the like according to a computer program 7 stored in the storage device 43.

The RAM 42 is configured by a volatile memory such as SDRAM and SDRAM, wherein a load module is expanded in execution of the computer program 7 to store temporary data and the like generated in the execution of the computer program 7.

The storage device 43 is configured by an embedded fixed storage device (hard disc) and the like. The computer program 7 stored in the storage device 43 is downloaded by the auxiliary storage device 47 from a portable recording medium 6 such as DVD, CD-ROM and flash memory recorded with information such as programs and data, and expanded to the RAM 42 from the storage device 43 in time of execution to be executed. Obviously, the computer program may be a computer program downloaded from an external computer through the communication device 46.

The communication device 46 is connected to the internal bus 48, and is connected to an external network such as Internet, LAN, and WAB to perform data transmission and reception with an external computer and the like. For instance, the storage device 43 is not limited to the configuration of being incorporated in the controller 4, and may be an external recording medium such as an external storage connected by way of the communication device 46.

The input device 44 is a data input medium such as keyboard and mouse. The display device 5 is a display device such as CRT monitor and LCD. The output device 45 is a printing device such as laser printer and inkjet printer.

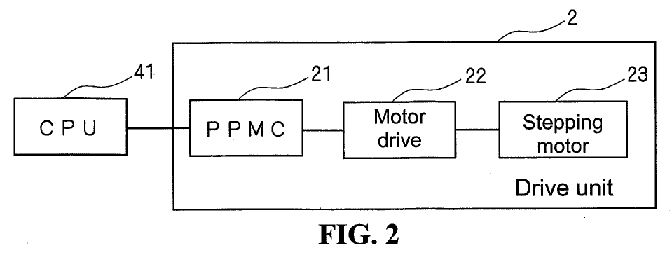

FIG. 2 is a block diagram showing a schematic configuration of the drive unit 2 of the sample analyzer 10 according to the embodiment of the present invention. As shown in FIG. 2, a PPMC (Pulse oscillator) 21 receiving an operation signal from the CPU 41 converts the operation signal to a command pulse signal, and transmits the command pulse signal to a motor drive 22. The motor drive 22 receiving the command pulse signal rotates a stepping motor 23 according to a number of pulses of the command pulse signal.

For instance, if the command pulse signal is a rotating direction control signal, the rotating direction of the stepping motor 23 is determined according to a digital value 1 or 0 indicating the rotating direction. The rotating speed of the stepping motor 23 can be changed according to the frequency of the command pulse signal.

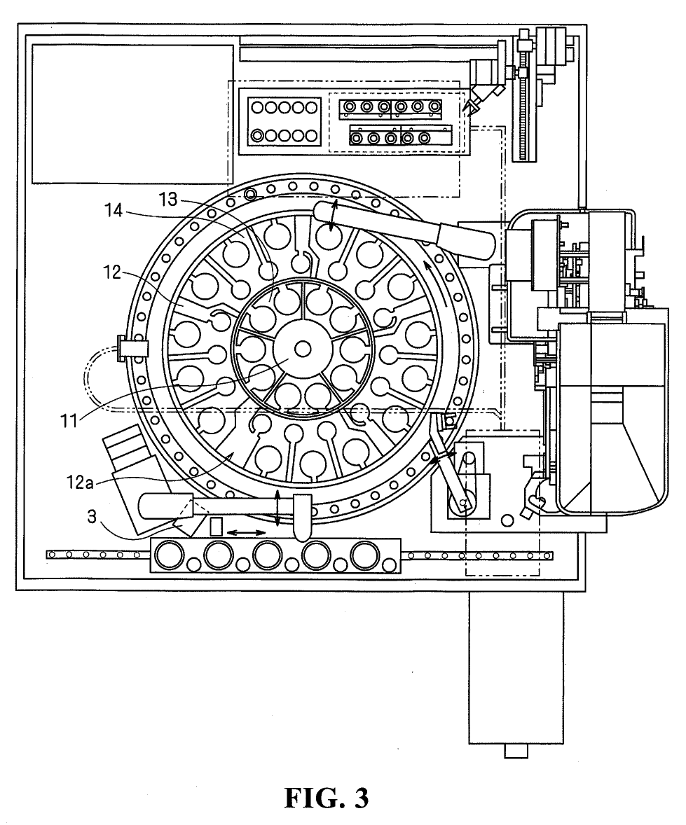

FIG. 3 is a partial plan view showing a brief overview of the sample analyzer 10 according to the embodiment of the present invention. In the present embodiment, the accommodation unit 1 is configured by a first sample table 11 of circular shape, a second sample table 12 of annular shape, and a plurality of first container racks 13, 13, . . . and second container racks 14, 14, . . . capable of accommodating the specimen container, the reagent container and the like; and the drive unit 2 includes a first stepping motor for rotating the first sample table 11 and a second stepping motor for rotating the second sample table 12. That is, the drive unit 2 has a configuration including a plurality of motor drives 22 and stepping motors 23.

When the operation signal is transmitted from the CPU 41 of the controller 4, each stepping motor 23 operates according to the command pulse signal converted in the drive unit 2, thereby respectively rotating the first sample table 11 and the second sample table 12. The drive unit 2 can rotate the first sample table 11 and the second sample table 12 in both clockwise direction and counterclockwise direction, and can rotate these sample tables independent from each other.

The plurality of first container racks 13, 13, . . . and the second container racks 14, 14, respectively . . . capable of accommodating the specimen container, the reagent container and the like are arranged to be detachably attached above the first sample table 11 and the second sample table 12. The plurality of first container racks 13, 13, . . . and the second container racks 14, 14, . . . are respectively attached with a barcode label. A barcode reader 3 is arranged with a predetermined distance in the vicinity of the side surface of the second sample table 12 in order to read the attached barcode label. The barcode reader 3 is also connected to be able to data communicate with the controller 4, and may, for example, convert the read barcode information to a pulse signal and transmit the pulse signal to the CPU 41.

If the second container racks 14, 14, . . . are arranged on the second sample table 12, a gap 12a of one location, of the gaps in which the second container racks 14, 14, . . . are adjacent to each other, has an interval larger than the gap of other four locations. That is, the barcode reader 3 reads the barcode information from the barcode label attached to the first container racks 13, 13, . . . arranged on the first sample table 11 positioned on the inner side of the second sample table 12 and the held container by way of the gap 12a having an interval larger than other gaps.

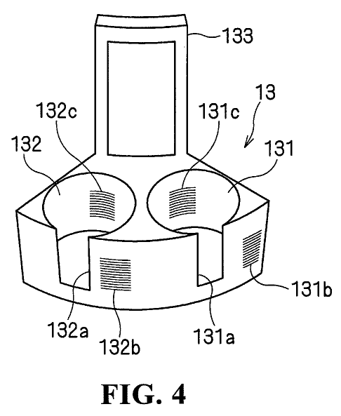

FIG. 4 is a perspective view showing a configuration of the first container rack 13. The first container rack 13 is configured by two holders 131, 132 for holding the container such as the specimen container or the reagent container, cutouts 131a, 132a respectively formed on the front surface side of the holders 131, 132, and a grip 133 arranged to project upward. The holders 131, 132 have a substantially circular shape when the accommodatable portion is seen from above so as to be able to hold a cylindrical container. When holding a container which outer shape is smaller than the inner diameter of the holder 131, 132, such container can be stably held by way of a separate adapter and the like.

A barcode label 131b, 132b is attached to an outer peripheral surface of the holder 131, 132. A barcode label 131c, 132c is also attached to the inner peripheral surface of the holder 131, 132.

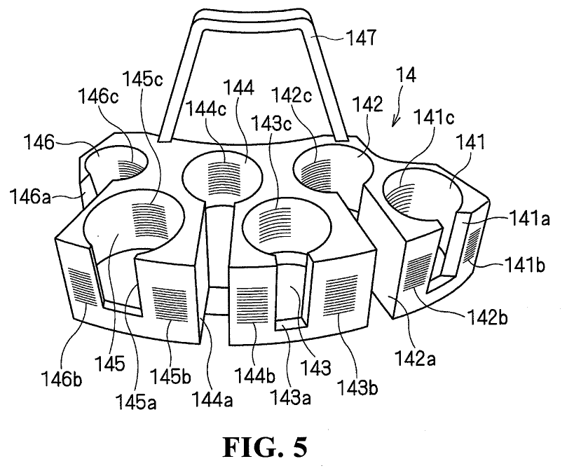

FIG. 5 is a perspective view showing a configuration of the second container rack 14. The second container rack 14 is configured by six holders 141 to 146 for holding the container such as the specimen container or the reagent container, cutouts 141a to 146a respectively formed on the front surface side of the holders 141 to 146, and a grip 147 arranged to project upward. The holders 141 to 146 have a substantially circular shape when the accommodatable portion is seen from above so as to be able to hold a cylindrical container 200. When holding a container which outer shape is smaller than the inner diameter of the holder 141 to 146, such container can be stably held by way of a separate adapter and the like.

A barcode label 141b to 146b is attached to an outer peripheral surface of the holder 141 to 146. A barcode label 141c to 146c is also attached to the inner peripheral surface of the holder 141 to 146.

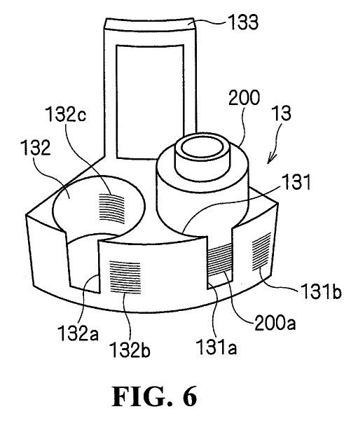

FIG. 6 is a perspective view showing a configuration of the first container rack 13 in a state of holding one container 200. The container 200 is held in the holder 131, and thus the barcode label 131c attached to the inner peripheral surface of the holder 131 cannot be read.

That is, when the barcode reader 3 reads the barcode label 200a attached to the container 200 without reading the barcode label 131c after reading the barcode label 131b, the CPU 41 of the controller 4 can judge that the container 200 incorporating the specimen or the reagent corresponding to the barcode information read from the barcode label 200a is being held.

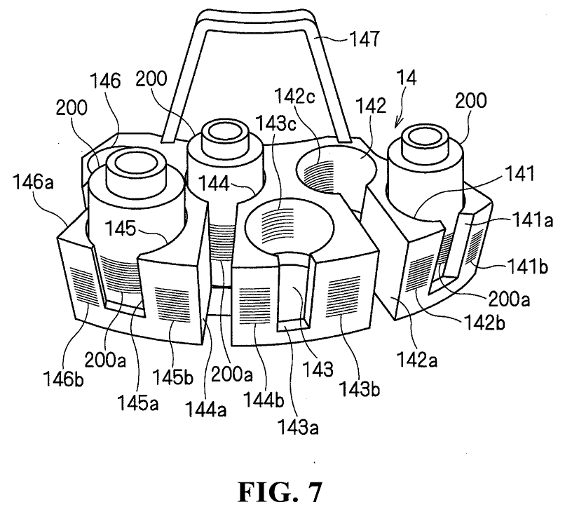

Similarly, FIG. 7 is a perspective view showing a configuration of the second container rack 14 in a state of holding three containers 200. The containers 200, 200, and 200 are held in the holders 141, 144, and 145, and thus the barcode labels 141c, 144c, and 145c attached to the inner peripheral surface of the holders 141, 144, and 145 cannot be read.

That is, when the barcode reader 3 reads the barcode label 200a attached to the container 200 without reading the barcode labels 141c, 144c, or 145c after reading the barcode label 141b, 144b, or 145b, the CPU 41 of the controller 4 can judge that the container 200 incorporating the specimen or the reagent corresponding to the barcode information read from the barcode label 200a is being held.

In the present embodiment, whether or not the container 200 is being held and whether or not the barcode information is normally read are first judged for all positions capable of holding the container 200 in the first container rack 13 and the second container rack 14. That is, the first sample table 11 and the second sample table 12 are rotated one round in a predetermined direction and speed to judge with the controller 4 whether or not all the containers 200 held in the first container rack 13 and the second container rack 14 mounted on the first sample table 11 and the second sample table 12 can be normally read with the barcode reader 3.

The distance to the position where the container 200 that is not normally read on the first time is held is specified, and the barcode information is read again using the barcode reader 3 only on the container 200 held at the specified distance. The reading conditions may be the same or changed between the first time and the second time. The reading conditions are conditions related to the reading method for reading the barcode information and the like, the reading setup of the barcode reader 3, and the like, and are stored in the storage device 43 in advance.

In the present embodiment, a laser method of irradiating and scanning laser light on the barcode label is used for the barcode reader 3. The barcode reader 3 receives the reflected light, and outputs a voltage signal corresponding to the received light quantity as a binarized voltage pulse signal. Whether or not the barcode information is normally read is judged by whether or not the voltage pulse signal acquired by the controller 4 from the barcode reader 3 is greater than or equal to a predetermined threshold value.

Therefore, for the reading condition, the threshold value for judging whether normally read or not may be changed. That is, the possibility that even the barcode label, which is judged that the voltage pulse signal acquired from the barcode reader 3 does not have sufficient strength in the reading of the first time, is judged as normally read in the second time increases by changing the threshold value to be lower in the second time than the first time.

In addition, the reading timing within one pulse for judging whether or not the barcode information read from the barcode label is normally read may be changed between the first time and the second time for the voltage pulse signal acquired from the barcode reader 3. The irradiation angle of the laser light to be irradiated from the barcode reader 3 to read the barcode information, that is, the readable angle of the barcode reader 3 may be changed between the first time and the second time.

Furthermore, the influence of the reflected light in the case where water droplets are attached to the barcode label is eliminated by changing to use a stabilization circuit for holding the signal output constant or amplifying the signal output by using a plurality of fixed gains without using the stabilization circuit with respect to the voltage signal output according to the received light quantity at the barcode reader 3.

The rotating direction and the rotating speed of the first sample table 11 and the second sample table 12 to be rotatably moved to read the barcode information may be changed. Therefore, the possibility of normally reading in the re-reading of the second time can be increased by changing the reading conditions between the first time and the second time.

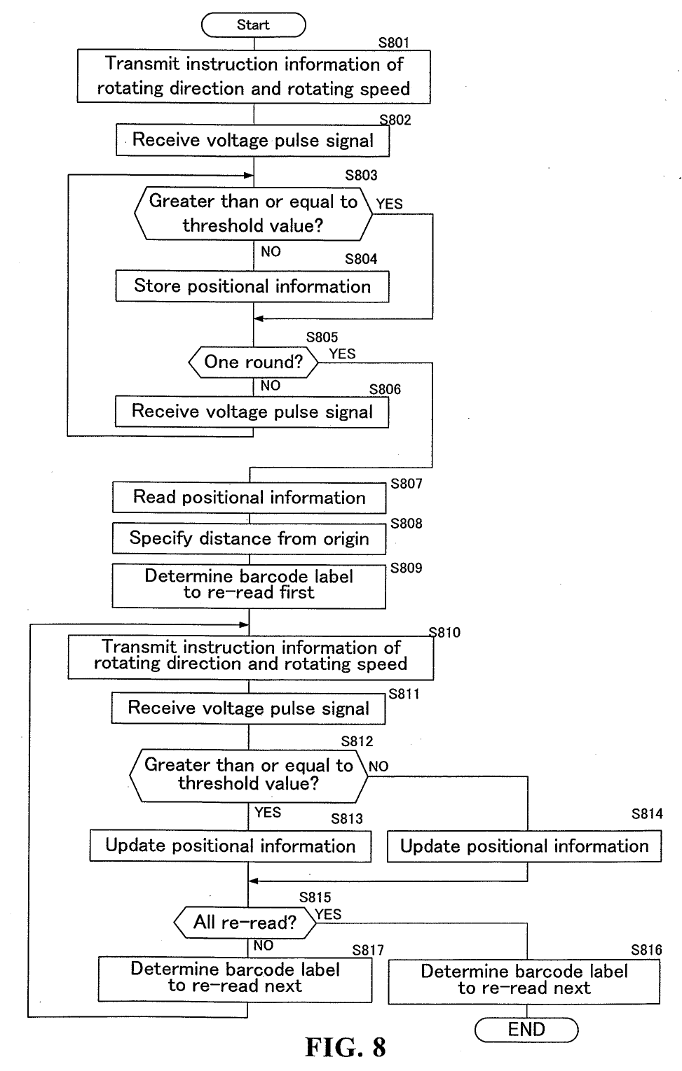

FIG. 8 is a flowchart showing processing procedures of the CPU 41 of the controller 4 of the sample analyzer 10 according to the embodiment of the present invention. In FIG. 8, the CPU 41 of the controller 4 transmits instruction information instructing the rotating direction and the rotating speed of the first sample table 11 and the second sample table 12 to the drive unit 2 (step S801), so that the first sample table 11 and the second sample table 12 rotate from a predetermined initial position to a position where the first barcode label faces the barcode reader, and the barcode reader 3 starts to read the barcode label in response to the instruction from the CPU 41. The CPU 41 receives a voltage pulse signal from the barcode reader 3 (step S802). The CPU 41 judges whether or not the barcode information is normally read from whether or not the voltage pulse signal received from the barcode reader 3 is greater than or equal to a predetermined threshold value (step S803).

If the CPU 41 judges that the voltage pulse signal is smaller than the predetermined threshold value (step S803: NO), the CPU 41 judges that the barcode information is not normally read, and stores the positional information related to the position of the barcode label that is not read in the storage device 43 (step S804).

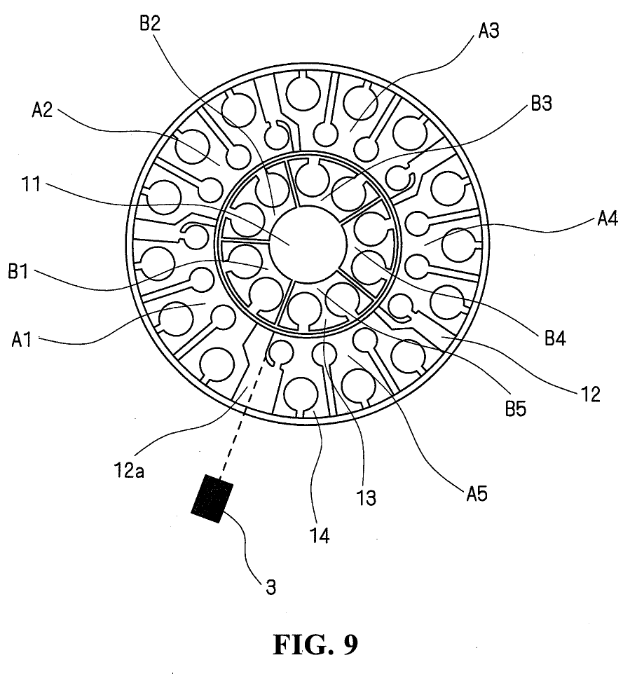

FIG. 9 is an explanatory view of a region to be read on the first sample table 11 and the second sample table 12. As shown in FIG. 9, the first container racks 13, 13, . . . and the second container racks 14, 14, . . . are mounted on the first sample table 11 and the second sample table 12, wherein the position on the right end of the gap 12a is the position of the front surface of the barcode reader 3, and the boundary of the first container racks 13, 13 is the position of the front surface of the barcode reader 3. This position is an initial position S in the present embodiment.

The region corresponding to the position of the rack in the case where the first container racks 13, 13, . . . and the second container racks 14, 14, . . . mounted on the first sample table 11 and the second sample table 12 exist at the initial position S is set as below. The region corresponding to the first container rack 13, 13, . . . is sequentially set as regions B1, B2, B3, B4, and B5 in a clockwise direction from the initial position S. The region corresponding to the second container rack 14, 14, is sequentially set as regions A1, A2, A3, A4, and AS in a clockwise direction from the initial position S. The regions A1, A2, A3, A4, and A5 may set a fixed region as regions A1, A2, A3, A4, and A5 or may set a variable region as regions A1, A2, A3, A4, and A5.

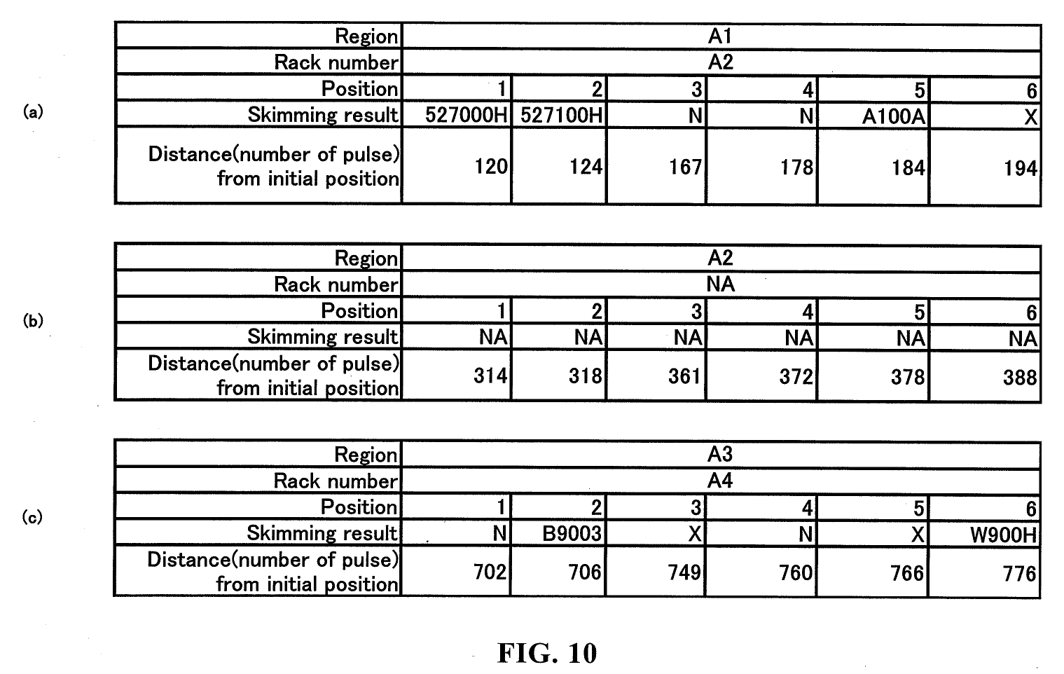

FIG. 10 is an illustrative view of the positional information stored in the storage device 43 including the case where the container 200 is accommodated in the first container rack 13, 13, . . . or the second container rack 14, 14, . . . . An item “region” indicates the region where the first container rack 13, 13, . . . or the second container rack 14, 14, . . . at the initial position S is mounted, and an item “rack number” is identification information of the first container rack 13, 13, . . . and the second container rack 14, 14, . . . mounted on the first sample table 11 and the second sample table 12 at the initial position S, and is described with the set region name.

For instance, in FIG. 10(a), the second container rack 14 first mounted at the “region” A2 is rotatably moved in a counterclockwise direction, and mounted at the “region” A1, that is, the first region in the clockwise direction of the initial position S. An item “position” indicates six accommodatable positions in the second container rack 14, wherein numbers 1 to 6 are sequentially given in the clockwise direction.

An item “skimming result” indicates the barcode information acquired when the barcode label is read by the barcode reader 3. That is, the portion where the identification information such as ‘527000H’, ‘527100H’, ‘A100A’ in FIG. 10(a) and ‘B9003’, ‘W900H’ in FIG. 10(c) is stored in the item “skimming result” means that the barcode label is normally read.

In the item “skimming result”, ‘N’ means that the barcode label indicating that the container 200 is not accommodated is normally read. For instance, it is found that in FIG. 10(a), the container 200 is not accommodated in the accommodatable positions 3 and 4, and in FIG. 10(c), the container 200 is not accommodated in the accommodatable positions 1 and 4.

In the item “skimming result”, ‘NA’ indicates that the first container rack 13, 13, . . . or the second container rack 14, 14, . . . itself is not mounted. That is, in FIG. 10(b), it is indicated that the second container rack 14 is not mounted in the region A2.

In the item “skimming result”, ‘x’ indicates that reading is normally carried out. That is, it is indicated that the barcode label given to the container 200 accommodated in the accommodatable position 6 in FIG. 10(a), or the barcode label given to the container 200 accommodated in the accommodatable positions 3 and 5 in FIG. 10(c) are respectively not normally read.

An item “distance (number of pulse) from initial position” indicates the rotation angle from the initial position S to the current accommodatable position with a number of drive pulses to output to the stepping motor 23. That is, the rotation angle by the stepping motor 23 can be obtained by storing the number of drive pulses from the initial position S where the first sample table 11 and the second sample table 12 start to rotate, and the rotation angle of the position attached with the barcode label that is not read can be specified.

The position specifying method of the barcode information is not limited to the method using positional information described above, and may be a method of separately installing an angular sensor such as a rotary encoder, and directly storing the rotation angle from the initial position S for the first sample table 11 and the second sample table 12.

Returning to FIG. 8, when the CPU 41 of the controller 4 judges that the voltage pulse signal is greater than or equal to the predetermined threshold value (step S803: YES), the CPU 41 judges whether or not the first sample table 11 and the second sample table 12 rotated one round (step S805). When the CPU 41 judges that both tables have not rotated one round (step S805: NO), the CPU 41 instructs the reading of the next barcode label, receives the obtained voltage pulse signal from the barcode reader 3 (Step S806), returns the process to step S803, and repeats the above processes. When the CPU 41 judges that the first sample table 11 and the second sample table 12 rotated one round (step S805: YES), the CPU 41 reads the positional information stored in the storage device 43 (step S807), and specifies the distance from a predetermined origin for each positional information (step S808).

In the present embodiment, the predetermined origin is the initial position S where the first sample table 11 and the second sample table 12 start to rotate. The manner of defining the predetermined origin is not particularly limited thereto, and may be any position as long as the rotation angle can be specified.

The CPU 41 determines the barcode label to be re-read first based on the specified distance (step S809), and transmits an instruction signal to the drive unit 2 to rotate the first sample table 11 and the second sample table 12 to the re-reading position of the barcode label (step S810). The CPU 41 again instructs reading of the barcode label and receives the voltage pulse signal from the barcode reader 3 (step S811).

The CPU 41 judges whether or not the barcode information is normally read with whether or not the voltage pulse signal received from the barcode reader 3 is greater than or equal to a threshold value (step S812). When the CPU 41 judges that the voltage pulse signal is greater than or equal to the threshold value (step S812: YES), the CPU 41 updates the positional information of the barcode label judged as being greater than or equal to the new threshold value of the positional information stored in the storage device 43 to the re-read information (step S813).

When judged that the CPU 41 is smaller than the threshold value (step S812: NO), the CPU 41 judges that the reading is again not normally carried out, and provides information indicating failure in re-reading to thereby update the positional information stored in the storage device 43 (step S814).

The CPU 41 judges whether or not the barcode label corresponding to all stored positional information is re-read (step S815), wherein when the CPU 41 judges that all barcode labels are re-read (step S815: YES), the CPU 41 displays information indicating that reading is not normally carried out at the position corresponding to the positional information remaining in the storage device 43 without being deleted (step S816). When the CPU 41 judges that re-reading of all barcode labels is not yet completed (step S815: NO), the CPU 41 determines the barcode label to be re-read next based on the specified distance (step S817), returns the process to step S810, and repeats the above processes.

If the barcode label in which re-reading is carried out but is not normally read does not exist, information indicating that reading is not carried out is obviously not always displayed in step S816.

Only the barcode label that is not normally read the first time is re-read by defining the order based on the distance to the barcode label, so that with respect to the identification information that is normally read, the display process to the screen, the aspiration process of the specimen or the reagent, and the like can be executed in parallel to the reading process of the second time without waiting for the re-reading result of the identification information that is not normally read, whereby the time required for the analyzing process as a whole can be shortened.

Therefore, in the present embodiment, re-reading is executed only on the container 200 accommodated at the position where reading is not normally carried out after reading the barcode labels for all positions. Therefore, the temporal loss of the rotational movement is small and the control is simple, whereby the throughput of the entire process can be minimized. Furthermore, the display of information indicating the barcode label that is normally read, the aspiration process of the specimen or the reagent, and the like can be executed in parallel to the re-reading of the barcode label that is not normally read, whereby the time required for the analyzing process as a while can be shortened.

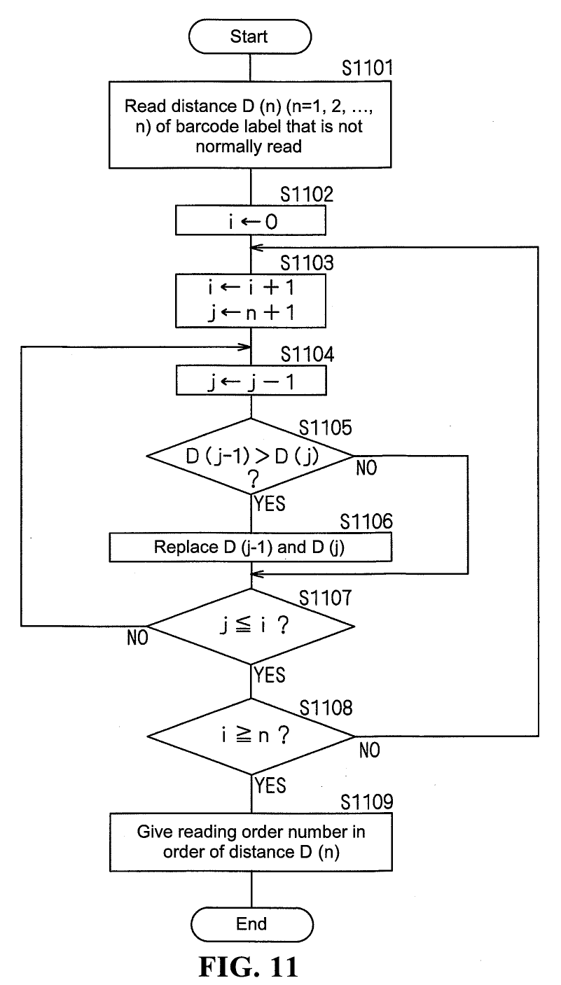

Moreover, the method of determining the reading order of the barcode label to be re-read based on the distance is not particularly limited. The re-reading order number may be given in the order of close distance. FIG. 11 is a flowchart showing processing procedures in determining the reading order of the CPU 41 of the controller 4 of the sample analyzer 10 according to the embodiment of the present invention.

The CPU 41 of the controller 4 reads the distance D(n) (n=1, 2, . . . , n) from the initial position S of the barcode label that is not normally read from the storage device 43 (step S1101), and sets the initial value of i to ‘0’ (step S1102). Here, n is the total number of barcode labels that is not normally read.

The CPU 41 increments i by one, and sets an initial value of j to ‘n+1’ (step S1103). The CPU 41 decrements j by one (step S1104), and judges whether or not the distance D(j−1) is greater than the distance D(j) (step S1105).

The CPU 41 replaces the distance D(j−1) and the distance D(j) (step S1106) when the CPU 41 judges that the distance D(j−1) is greater than the distance D(j) (step S1105: YES), and the CPU 41 skips step S1106 and judges whether or not j is smaller than or equal to i (step S1107) when the CPU 41 judges that the distance D(j−1) is smaller than or equal to the distance D(j) (step S1105: NO).

When the CPU 41 judges that j is greater than i (step S1107: NO), the CPU 41 returns the process to step S1104, and repeats the above processes. When the CPU 41 judges that j is smaller than or equal to i (step S1107: YES), the CPU 41 judges whether or not i is greater than or equal to n (step S1108).

When the CPU 41 judges that i is smaller than n (step S1108: NO), the CPU 41 returns the process to step S1103, and repeats the above processes. When the CPU 41 judges that i is greater than or equal to n (step S1108: YES), the CPU 41 gives a reading order number of the barcode label on the order of sorted distance D(n) (step S1109), and stores the same in the storage device 43. The CPU 41 executes the process of FIG. 8 in the order of the reading order number determined in the above process.

Thus, the movement time to the reading position is minimized by executing the re-reading of the barcode label in the order of short distance, whereby the re-reading time can be shortened. The process of determining the reading order is not limited to the bubble sort described above, and is not particularly limited as long as it is a procedure of sorting in the order of short distance.

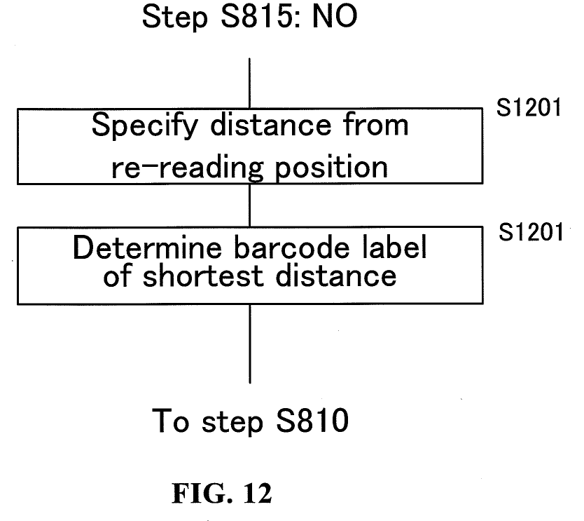

When determining the barcode label to re-read next in step S817 of FIG. 8, it is preferable to determine the barcode label closest to the moved re-reading position. This is because the movement distance becomes the shortest, and the re-reading time can be shortened. FIG. 12 is a flowchart showing processing procedures of the CPU 41 of the controller 4 of the sample analyzer 10 when obtaining a distance from the re-reading position.

In FIG. 12, the CPU 41 of the controller 4 judges whether or not the barcode label corresponding to all stored positional information is re-read (step S815), wherein when the CPU 41 judges that the re-reading of all barcode labels is not completed (step S815: NO), the CPU 41 specifies the distance between the current re-reading position and the barcode label not completed with re-reading, which is the target of the next re-reading, based on the positional information stored in the storage device 43 (step S1201).

The CPU 41 determines the barcode label which distance with the current re-reading position is the shortest as the barcode label to be re-read next (step S1202), returns the process to step S810, and repeats the above processes.

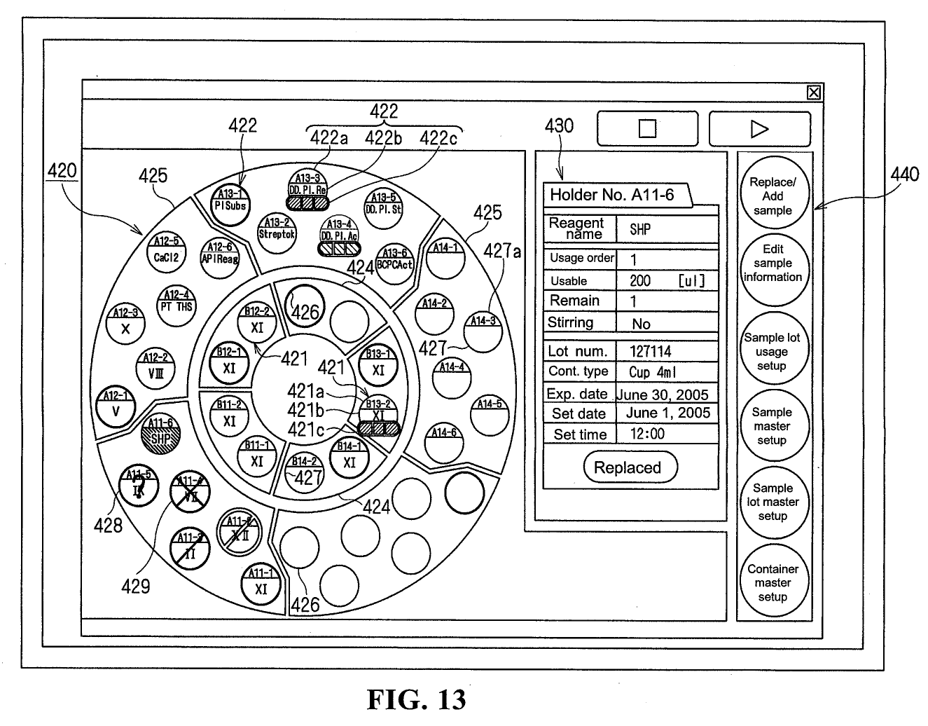

FIG. 13 is an illustrative view of a screen displayed on the display device 5. The screen displaying the situation of the sample analyzer 10 includes an arrangement display region 420 displaying the position and the container holdable position of the first container rack 13 and the second container rack 14 mounted on at least the first sample table 11 and the second sample table 12; a detailed information display region 430 displaying detailed information related to the content of the container held at the selected position; and an operation display region 440 instructing operation.

The arrangement display region 420 displays a maximum of ten first sample marks 421, 421, . . . displayed in correspondence to the arrangement situation of at least the first sample 11, and a maximum of thirty second sample marks 422, 422, . . . displayed in correspondence to the arrangement situation of the second sample table 12. The first sample mark 421 includes a position display portion 421a displaying the position, a name display portion 421b displaying the name of the sample, and a remaining amount display portion 421c displaying the remaining amount of the sample. Similarly, the second sample mark 422 includes a position display portion 422a displaying the position, a name display portion 422b displaying the name of the sample, and a remaining amount display portion 422c displaying the remaining amount of the sample. The remaining amount display portions 421c, 422c are displayed only when the remaining amount of the sample becomes lower than or equal to a predetermined amount.

The positional information of the sample displayed on the position display portions 421a, 422a of the first sample mark 421 and the second sample mark 422 is displayed when the barcode reader 3 reads the barcode label attached to the first container rack 13 and the second container rack 14. The name of the sample displayed on the name display portions 421b, 422b is included in the barcode information read from the barcode label 200a attached to the container 200 accommodating the sample, and is displayed by referencing the sample master and the like stored in the storage device 43 based on the signal read by the barcode reader 3.

The first sample mark 421 is displayed by being divided into first rack marks 424, 424, . . . corresponding to five first container racks 13, 13, . . . capable of holding two containers 200, 200 arranged on the first sample table 11. The second sample mark 422 is displayed by being divided into second rack marks 425, 425, . . . corresponding to five second container racks 14, 14, . . . capable of holding six containers 200, 200 arranged on the second sample table 12. Therefore, which position of which container rack of which sample table the sample is arranged can be visually checked.

If the container rack is not arranged on the first sample table 11 and the second sample table 12, a circular rack non-arranged mark 426 in which nothing is displayed on the inner side is displayed on the arrangement display region 420. Furthermore, a sample non-arranged mark 427 is displayed in the region corresponding to the position where the first container rack 13 and the second container rack 14 are respectively arranged in the first sample table 11 and the second sample table 12 but the container 200 with the sample is not arranged. The sample non-arranged mark 427 includes a position display portion 427a displaying the positional information.

If the reading of the barcode label 200a attached to the container 200 fails, a reading error mark 428 is displayed on the sample mark accommodating the container 200 which reading failed. Therefore, the position of the container 200 that is not normally read on the first time can be visually recognized as being the position where the reading error mark 428 is displayed.

If the reading fails even if the barcode label 200a attached to the container 200 is again read, a re-reading error mark 429 is displayed on the sample mark accommodating the container 200 which reading failed. Therefore, the position of the container 200 that is not normally read also in re-reading can be visually recognized as being the position where the reading error mark 429 is displayed.

In the embodiment described above, the positional information of the barcode label that is not normally read is specified by the number of drive pulses necessary for rotation driving from the initial position S, but is not limited thereto, and for example, position number information may be provided in order from the initial position S, and a positional information table in which the position number information and the number of drive pulses are corresponded may be stored in the storage device 43. The positional information of the barcode label that is not normally read thus only requires the position number information.

If the reading is not normally carried out even if re-read, “re-read button” and the like may be display output on the display screen shown in FIG. 12, and re-reading may be executed when “re-read button” is selected by a mouse and the like. The identification information to be re-read may be manually input from the keyboard and the like.

The embodiment described above may be changed within a scope not deviating from the concept of the present invention. In other words, the accommodation unit 1 accommodating the specimen container, the reagent container, and the like is not limited to a configuration of being rotatably moved by the drive unit 2, and may be linearly moved as long as it can be relatively moved to the position readable by the barcode reader 3. The identification information is not limited to the barcode information, and may be a three-dimensional code such as QR code. Furthermore, it goes without saying that the identification information may be read through wireless communication using an IC chip. Moreover, the number of readings on one identification information is not limited to two times, and re-reading may be repeated to a settable predetermined number of times.

The identification information reader such as the barcode reader 3 is not limited to being fixed, and it goes without saying that a mechanism and a drive source may be arranged such that the identification information reader side can be moved.

In the embodiment described above, re-reading is carried out only on the barcode label in which reading of the first time failed, but re-reading may be carried out including the barcode label in which reading of the first time succeeded.

The reading of the barcode label may be performed after stopping the rotation of the first sample table 11 and the second sample table 12, but may be performed during the rotation of the tables.

In the embodiment described above, a stepping motor is used for the drive source for rotating the sample table, but a servo motor may be used as the drive source and the distance (number of pulses) from the initial value may be stored in the storage device 43 by using an encoder.

What is claimed is:

1. A sample analyzer for analyzing a measurement sample prepared by mixing a specimen and a reagent, comprising:
a movement unit for moving at least one of a specimen container, a reagent container, and an accommodation unit for accommodating the specimen container or the reagent container, wherein at least one of the specimen container, the reagent container and the accommodation unit is provided with identification information;
an identification data acquirer for reading at least one of identification information provided to the specimen container, identification information provided to the reagent container, and identification information provided to the accommodation unit; and
a controller for controlling operations of the movement unit and the identification data acquirer such that
the movement unit moves each identification information so that the identification data acquirer sequentially reads identification information;
the controller judges whether or not each identification information is normally read by the identification data acquirer;
the movement unit moves each identification information so that the identification data acquirer reads identification information again which judged as being not normally read; and
the identification data acquirer reads identification information moved to a read position at which identification information is readable.

2. The sample analyzer according to claim 1, wherein the controller specifies a distance from the read position to identification information for every identification information judged as being not normally read, and controls the operation of the movement unit based on the specified distance.

3. The sample analyzer according to claim 2, wherein when identification information judged as being not normally read by the controller is in plurals, the controller re-reads one of identification information, and thereafter specifies a movement distance of the movement unit necessary for re-reading the next identification information.

4. The sample analyzer according to claim 1, wherein when identification information judged as being not normally read by the identification data acquirer is in plurals, the controller determines order of re-reading of identification information judged as being not normally read, and controls the operation of the movement unit based on the determined re-reading order.

5. The sample analyzer according to claim 1, further comprising:
a rotatable table for holding at least one of the specimen container, the reagent container, and the accommodation unit; wherein
the movement unit includes a drive source for rotatably moving the rotatable table on a substantially horizontal plane.

6. The sample analyzer according to claim 2, further comprising:
a rotatable table for holding at least one of the specimen container, the reagent container, and the accommodation unit; wherein
the movement unit includes a drive source for rotatably moving the rotatable table on a substantially horizontal plane; and
the controller specifies the distance based on a number of pulses necessary for moving identification information to be re-read to the read position by the drive source.

7. The sample analyzer according to claim 1, further comprising:
a display unit; wherein
the controller again judges whether or not identification information judged as being not normally read is normally read by the identification data acquirer, and controls the display unit to display that reading is not normally carried out if judged again as not normally read.

8. The sample analyzer according to claim 1, further comprising:
a rotatable table for holding at least one of the specimen container, the reagent container, and the accommodation unit; wherein
the controller controls the operation of the movement unit and the identification data acquirer so that the identification data acquirer re-reads identification information judged as being not normally read after reading of all identification information provided to the container held on the rotatable table is terminated.

9. A sample analyzer for analyzing a measurement sample prepared by mixing a specimen and a reagent, comprising:
an identification data acquirer for reading identification information provided to identify at least one of a specimen container, a reagent container, and an accommodation unit for accommodating the specimen container or the reagent container;
a movement unit for moving the identification data acquirer; and
a controller for controlling operations of the movement unit and the identification data acquirer such that
the identification data acquirer sequentially reads identification information;
the controller judges whether or not each identification information is normally read by the identification data acquirer;
the movement unit moves the identification data acquirer so that the identification data acquirer reads identification information again which judged as being not normally read; and
the identification data acquirer reads identification information when the identification data acquirer is moved to a read position for reading identification information.

10. A sample analyzing method executed in a sample analyzer for analyzing a measurement sample prepared by mixing a specimen and a reagent, comprising the steps of:
(a) moving each identification information so that an identification data acquirer for reading at least one of identification information provided to a specimen container, identification information provided to a reagent container, and identification information provided to an accommodation unit for accommodating the specimen container or the reagent container sequentially reads identification information;
(b) judging whether or not each identification information is normally read by the identification data acquirer;
(c) moving each identification information so that the identification data acquirer performs re-reading of identification information judged as being not normally read after the reading of each identification information is terminated; and
(d) reading identification information moved to a read position readable by the identification data acquirer.

11. The sample analyzing method according to claim 10, further comprising the step of:
(e) specifying distance from the read position to identification information for every identification information judged as being not normally read in (b), wherein
(d) includes a step of controlling the operation of (a) based on the specified distance.

12. The sample analyzing method according to claim 11, wherein when identification information judged as being not normally read in (b) is in plurals, (e) includes a step of re-reading one identification information, and thereafter specifying a movement distance necessary for re-reading the next identification information in (a).

13. The sample analyzing method according to claim 10, further comprising a step of:
(f) determining order of re-reading of the plural identification information when identification information judged as being not normally read in (b) is in plurals; wherein
(c) includes a step of moving identification information based on the determined re-reading order.

14. The sample analyzing method according to claim 10, wherein (a) includes a step of rotatably moving a rotatable table for holding at least one of the specimen container, the reagent container, and the accommodation unit provided with the identification information on a substantially horizontal plane.

15. The sample analyzing method according to claim 11, wherein
(a) includes a step of rotatably moving a rotatable table for holding at least one of the specimen container, the reagent container, and the accommodation unit on a substantially horizontal plane; and
(e) includes a step of specifying the distance based on a number of pulses necessary for moving identification information to be re-read to the read position.

16. The sample analyzing method according to claim 10, further comprising a step of:
(g) again judging whether or not identification information judged as being not normally read in (b) is normally read by the identification data acquirer; and
indicating information that reading is not normally carried out is displayed if again judged as being not normally read.

17. The sample analyzing method according to claim 10, wherein
(c) includes a step of controlling the operation of (a) so that the identification data acquirer re-reads the identification information judged as being not normally read in (b) after reading is terminated for all identification information provided to the container held on a rotatable table for holding at least one of the specimen container, the reagent container, and the accommodation unit.

18. A computer program product, comprising:
a computer readable medium; and instructions, on the computer readable medium, adapted to enable a general purpose computer to perform operations, comprising:
(a) moving each identification information so that an identification data acquirer for reading at least one of identification information provided to a specimen container, identification information provided to a reagent container, and identification information provided to an accommodation unit for accommodating the specimen container or the reagent container sequentially reads identification information;
(b) judging whether or not each identification information is normally read by the identification data acquirer;
(c) moving each identification information so that the identification data acquirer performs re-reading of identification information judged as being not normally read after the reading of each identification information is terminated; and
(d) reading identification information moved to a read position readable by the identification data acquirer.

19. The computer program product according to claim 18, further comprising:
(e) specifying distance from the read position to identification information for every identification information judged as being not normally read in (b), wherein
(d) includes a step of controlling the operation of (a) based on the specified distance.

20. The computer program product according to claim 18, wherein
when identification information judged as being not normally read in (b) is in plurals, (e) includes a step of re-reading one identification information, and thereafter specifying a movement distance by (a) necessary for re-reading the next identification information.
